(19) United States
(12) Patent Application Publication
(10) Pub. No.: US 2016/0117247 A1
(43) Pub. Date: Apr. 28, 2016

(54) COHERENCY PROBE RESPONSE ACCUMULATION

(71) Applicant: Advanced Micro Devices, Inc., Sunnyvale, CA (US)

(72) Inventors: Eric Morton, Austin, TX (US); Patrick Conway, Los Altos, CA (US); Alan Dodson Smith, Lakeway, TX (US); Greggory Douglas Donley, San Jose, CA (US); Vydhyanathan Kalyanasundharam, San Jose, CA (US)

(21) Appl. No.: 14/523,024

(22) Filed: Oct. 24, 2014

(51) Int. Cl. G06F 12/08; G06F 11/30; G06F 11/34

(52) U.S. Cl. CPC G06F 12/0815; G06F 11/3409; G06F 11/3037; G06F 2212/604

(57) ABSTRACT

A processor accumulating coherency probe responses, thereby reducing the impact of coherency messages on the bandwidth of the processor's communication fabric. A probe response accumulator is connected to a processing module of the processor, the processing module having multiple processor cores and associated caches. In response to a coherency probe, the processing module generates a different coherency probe response for each of the caches. The probe response accumulator combines the different coherency probe responses into a single coherency probe response and communicates the single coherency response over the communication fabric.

### BACKGROUND

1. Field of the Disclosure

The present disclosure relates generally to processors and more particular to memory coherency for processors.

2. Description of the Related Art

As processors have scaled in performance, they have increasingly employed multiple processing elements, such as multiple processor cores and multiple processing units (e.g., one or more central processing units integrated with one or more graphics processing units). To enhance processing efficiency, reduce power, and provide for small device footprints, a processor typically employs a memory hierarchy wherein the multiple processing elements share a common system memory and are each connected to one or more dedicated memory units (e.g. one or more caches). The processor enforces a memory coherency protocol to ensure that a processing element does not, at its dedicated memory unit, concurrently access (read or write) data that is being modified by another processing unit at its dedicated memory unit. To comply with the memory coherency protocol, the processing elements transmit coherency messages (i.e., coherency probes and probe responses) over a communication fabric of the processor. However, in processors with a large number of processing elements, the relatively high number of coherency messages can consume an undesirably large portion of the communication fabric bandwidth, thereby increasing the power consumption and reducing the efficiency of the processor.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor in accordance with some embodiments.

FIG. 2 is a block diagram of a probe response accumulator of FIG. 1 in accordance with some embodiments.

FIG. 3 is a diagram illustrating example operations of the probe response accumulator of FIG. 2 in accordance with some embodiments.

FIG. 4 is a diagram illustrating additional example operations of the probe response accumulator of FIG. 2 in accordance with some embodiments.

FIG. 5 is a flow diagram of a method of accumulating coherency probe responses in accordance with some embodiments.

FIG. 6 is a flow diagram of a method of updating coherency information based on accumulated coherency probe responses in accordance with some embodiments.

FIG. 7 is a flow diagram illustrating a method for designing and fabricating an integrated circuit device implementing at least a portion of a component of a processing system in accordance with some embodiments.

### DETAILED DESCRIPTION

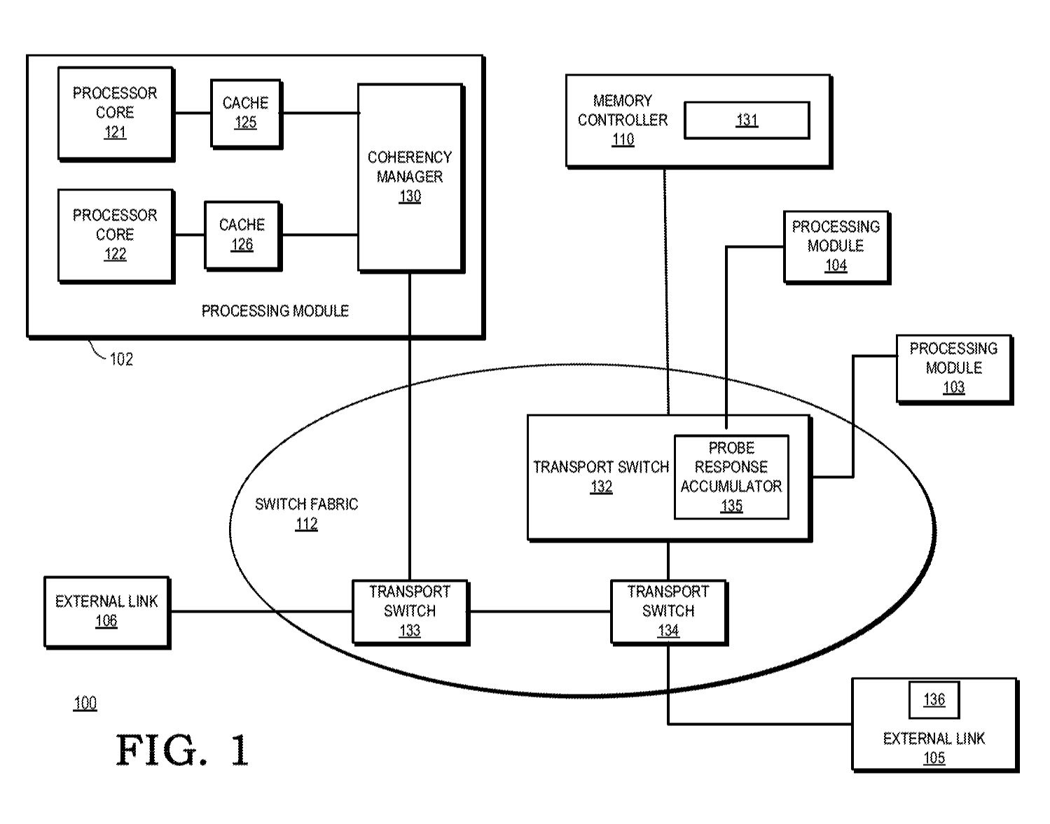

FIGS. 1-7 illustrate techniques for accumulating coherency probe responses at a node of a processor, thereby reducing the impact of coherency messages on the bandwidth of the processor's communication fabric. A probe response accumulator is connected to a processing module of the processor that has multiple processor cores and associated caches. In response to a coherency probe, the processing module generates a separate coherency probe response for each of the caches. The probe response accumulator combines the resulting coherency probe responses from the caches into a single coherency probe response and communicates the single coherency response over the communication fabric. The probe response accumulator thus reduces the overall number of coherency probe responses that are communicated over the fabric, reducing power consumption and improving processor efficiency.

FIG. 1 illustrates a block diagram of a processor 100 in accordance with some embodiments. The processor 100 includes processing modules 102-104, external links 105 and 106, a memory controller 110, and a switch fabric 112. In some embodiments, the processor 100 is packaged in a multichip module format, wherein the processing modules 102-104 and the memory controller 110 are each formed on different integrated circuit die and then packaged together, with interconnects between the dies forming at least a portion of the switch fabric 112. In some embodiments, the memory controller 110 is connected to memory modules packaged separately. The processor 100 is generally configured to be incorporated into an electronic device, and to execute sets of instructions (e.g., computer programs, apps, and the like) to perform tasks on behalf of the electronic device. Examples of electronic devices that can incorporate the processor 100 include desktop or laptop computers, servers, tablets, game consoles, compute-enabled mobile phones, and the like.

The memory controller 110 is connected to one or more memory modules (not shown) that collectively form the system memory for the processor 100. The memory modules can include any of a variety of memory types, including random access memory (RAM), flash memory, and the like, or a combination thereof. The memory modules include multiple memory locations, with each memory location associated with a different memory address. In the illustrated example, the memory controller 110 includes a coherency manager 131 to perform coherency operations on behalf of the memory modules, including identification of coherency states for each memory location, issuance of coherency probes to identify the coherency states, and the like.

The external links 105 and 106 each provide an interface to one or more connected devices (not shown) external to the processor 100. Examples of the external links can include additional processors, input/output devices, storage controllers, and the like.

The switch fabric 112 is a communication fabric that routes messages between the processing modules 102-104, and between the processing modules 102-104 and the memory controller 110. Examples of messages communicated over the switching fabric 112 can include memory access requests (e.g., load and store operations) to the memory 110, status updates and data transfers between the processing modules 102-104, and coherency probes and coherency probe responses (sometimes referred to herein simply as “probe responses”).

The processing module 102 includes processor cores 121 and 122, caches 125 and 126, and a coherency manager 130. The processing modules 102-105 include similar elements as the processing module 102. In some embodiments, different processing modules can include different elements, including different numbers of processor cores, different numbers of caches, and the like. Further, in some embodiments the processor cores or other elements of different processing modules can be configured or designed for different purposes. For example, in some embodiments the processing module 102 is designed and configured as a central processing unit to execute general purpose instructions for the processor 100 while the processing module 102 is designed and configured as a graphics processing unit to perform graphics processing for the processor 100. In addition, it will be appreciated that although for purposes of description the processing module 102 is illustrated as including a single dedicated cache for each of the processor cores 121 and 122, in some embodiments the processing modules can include additional caches, including one or more caches shared between processor cores, arranged in a cache hierarchy.

The switching fabric includes a number of transport switches, (e.g., transport switches 132, 133, and 134). Each transport switch is connected to one or more of a processing module, another transport switch, or external link. For example, the transport switch 132 is connected to the processing module 102, the transport switch 134, and the external link 106. Each of the transport switches is configured to receive messages from its connected modules and to route received messages to one or more of its connected modules based on an address of the message and a set of specified routing rules. Messages traverse the switch fabric 112 by hopping from one transport switch to another until the message is routed to its destination (typically a processing module or external link). In some embodiments, each transport switch provides physical, or PHY, layer functions such as message buffering, flow control, error correction, multiplexing, and the like. In some embodiments, a transport switch can perform additional functions, such as message buffering. To communicate with another processing module, an element of a processing module forms a set of information, referred to as a message, indicating the destination(s) of the message, any data to be transferred via the message, the type of message, and the like, and provides the message to its connected transport switch, which then routes the message to its destination.

Each of the processing modules 102-104 includes a coherency manager (e.g., coherency manager 130 of processing module 102) and the coherency managers together enforce the coherency protocol for the processor 100. The coherency protocol is a set of rules that ensure that different ones of the processing modules 102-104 do not concurrently modify, at their local cache hierarchy, data associated with the same memory location of the memory 110. For purposes of description, the processor 100 implements the MOESIF protocol. However, it will be appreciated that in some embodiments the processor 100 can implement other coherency protocols, such as the MOESI protocol, the MESI protocol, the MOSI protocol and the like.

For purposes of description, an element of a processing module that can seek to access data associated with a particular memory location of the memory 110 is referred to as a coherency agent. The coherency protocol defines a set of coherency states and the rules for how data associated with a particular memory location of the memory is to be treated by a coherency agent based on the coherency state of the data at each of the processing modules 102-104. To illustrate, different ones of the processing modules 102-104 can attempt to store, at their local caches, data associated with a common memory location of the memory 110. The coherency protocol establishes the rules for whether multiple coherency agents can keep copies of data corresponding to the same memory location at their local caches, which coherency agent can modify the data, and the like.

To enforce the coherency protocol, the coherency managers of the processing modules 102-104 exchange messages, referred to as coherency messages, via the transport switches of the switch fabric 112. Coherency messages fall into one of at least two general types: a coherency probe that seeks the coherency state of data associated with a particular memory location at one or more of the processing modules 102-104, and a probe response that indicates the coherency state, transfers data in response to a probe, or provides other information in response to a coherency probe. To illustrate via an example, the coherency manager 130 can monitor memory access requests issued by the processor cores 121 and 122. In response to a memory access request to retrieve data from a memory location of the memory 110, the coherency manager 130 can issue a coherency probe to each of the processing modules 102-104 requesting the coherency state for the requested data at the caches of each module. In some embodiments, the memory controller 110 includes a coherency manager 131 that issues coherency probes in response to memory access requests received at the memory controller 110.

The coherency managers at each of the processing modules 102-104 receive the coherency probes, identify which (if any) of their local caches stores the data, and identify the coherency state of each cache location that stores the data. The coherency managers generate probe responses to communicate the coherency states for the cache locations that store the data, together with any other responsive information. In some embodiments, the coherency managers collectively generate a different probe response for each cache location that stores the data referenced in a coherency probe. In a conventional processor, each probe response would be communicated via the switch fabric 112 to the coherency manager that generated the coherency probe. In a processor with a large number of coherency agents, a large number of coherency responses can be generated, thereby consuming a large amount of the bandwidth of the switch fabric 112. Accordingly, one or more of the transport switches of the processor 100 includes a probe response accumulator (e.g., probe response accumulator 135 of the transport switch 132) that is configured to combine probe responses into a single probe response, thereby reducing the number of probe responses that are communicated via the switch fabric 112.

To illustrate via an example, the coherency manager 130 receives via the switch fabric 112. In response to the coherency probe, the coherency manager 130 determines that each of the caches 125 and 126 stores data corresponding to the memory location indicated by the coherency probe. Accordingly, the coherency manager 130 generates separate probe responses for each of the caches 125 and 126 and provides them to the transport switch 132. The probe response accumulator 135 combines the two probe responses into a single combined probe response, and communicates the combined probe response to the processing module that generated the coherency probe or to another processing module as indicated by the coherency probe.

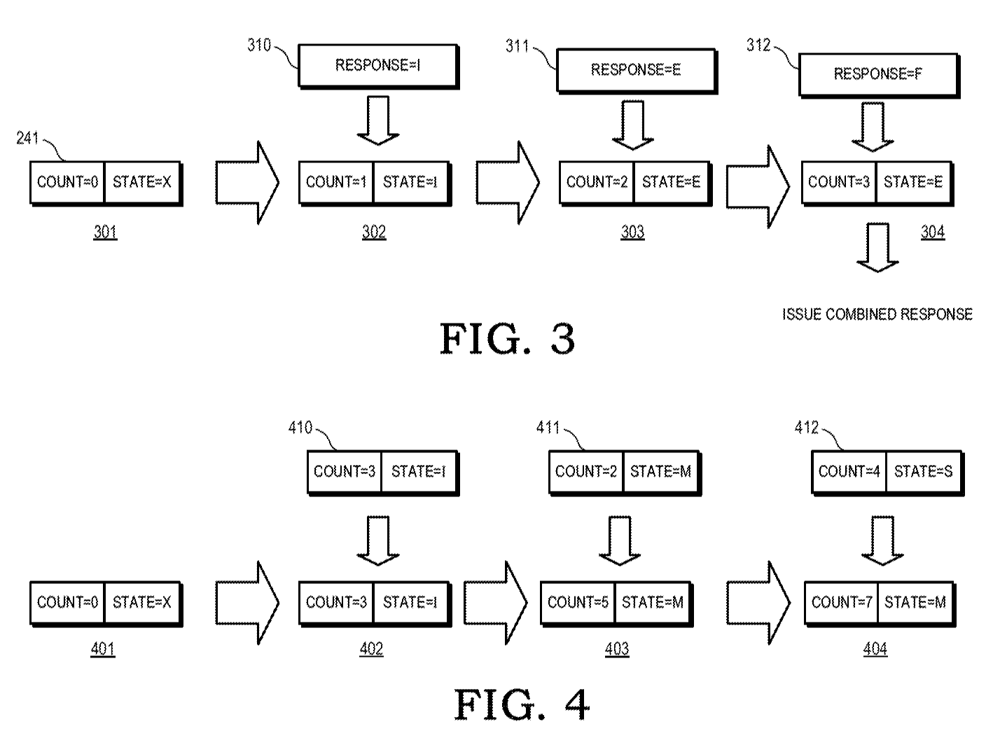

In some embodiments, the probe response accumulator 135 combines the received probe responses by determining, between all of the received probe responses, the highest coherency state in a state hierarchy defined by the coherency protocol. The hierarchy indicates among a given set of states which of those states is guaranteed to maintain coherency for a memory location. To illustrate, in the MESIF protocol the hierarchy can be defined as follows: I, S, F, E, M, where I is the lowest state in the hierarchy and M is the highest state in the hierarchy. This hierarchy establishes an order such that for a given set of coherency states received in a given set of probe responses, a coherency manager should follow the rules of the coherency protocol for the highest state in the hierarchy in order to guarantee memory coherency. Thus, for example, if a coherency probe were to result in probe responses indicating coherency states of I, S, and F, the receiving coherency manager should follow the rules of the coherency protocol for the F (forward) in order to guarantee memory coherency. Accordingly, and as described further below in the examples of FIG. 3 and FIG. 4, to combine probe responses the probe response accumulator 135 can set the coherency state of the combined probe response to the highest coherency state in the hierarchy between all the received probe responses. This ensures that memory coherency will be maintained. In some embodiments, the coherency states are encoded such that the highest state in the hierarchy between probe responses can be identified by logically combining (e.g., logically ORing) the coherency states of the probe responses.

In some embodiments, different types of coherency probes can require different types of probe responses, such that for some types of coherency probes the probe responses cannot be combined. For example, some types of coherency probes seek only to determine the coherency state of data associated with a particular memory location. For purposes of discussion, these types of coherency probes are referred to as “coherency status probes”. Other coherency probes seek the transfer of data from one or more coherency agents to one or more other coherency agents. For purposes of discussion, these types of coherency probes are referred to as “data transfer probes”. In some embodiments, coherency status probes are suitable for combined probe responses while data transfer probes are not. Accordingly, for each received coherency probe the probe response accumulator 135 can identify the type of coherency probe and accumulate probe responses only for those coherency probe types that are suitable for probe response accumulation, as described further herein.

In some embodiments, one or more of the external links of the processor 100 can include a probe response accumulator (e.g., probe response accumulator 136 of external link 105). A probe response accumulator at an external link can accumulate probe responses for coherency probes received via the external link. In addition or alternatively, the probe response accumulator at an external link can accumulate probe responses received via the external link.

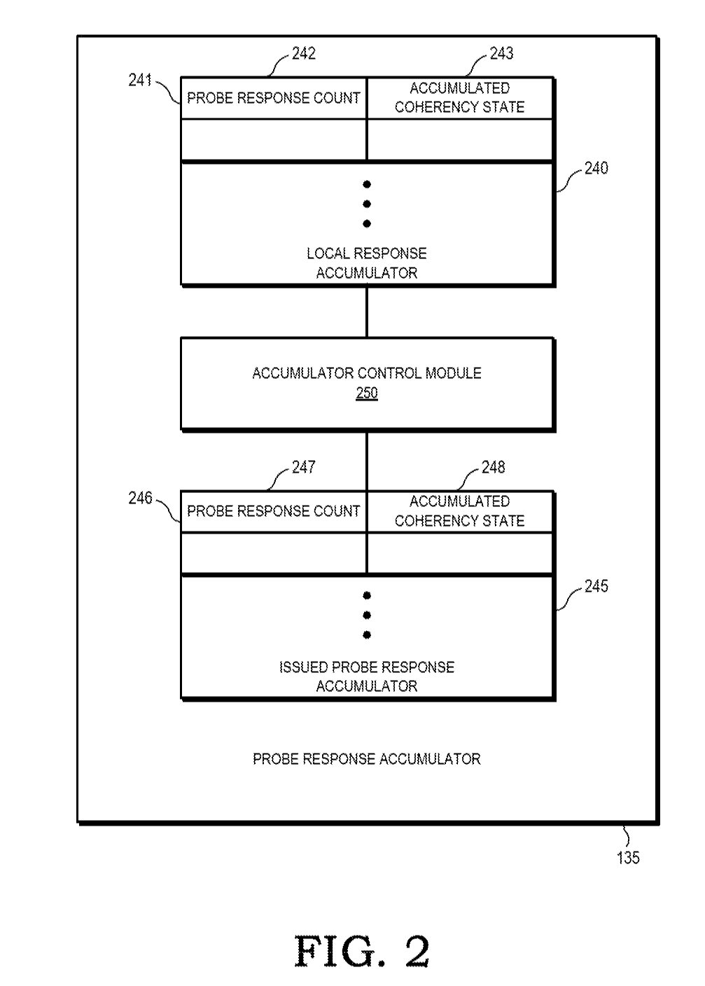

FIG. 2 illustrates a block diagram of the probe response accumulator 135 of FIG. 1 in accordance with some embodiments. The probe response accumulator 135 includes a local response accumulator 240, an issued probe response accumulator 245, and an accumulator control module 250. The local response accumulator 240 is a memory structure generally configured to store accumulated probe responses based on probe responses generated locally by the coherency manager 130. The issued probe response accumulator 245 is a memory structure generally configured to store accumulated probe responses received from the switch fabric 112 that are responsive to coherency probes generated by the coherency manager 130. The accumulator control module 250 is generally configured to manage the accumulation and storage of probe responses, as well as the other operations of the local response accumulator 240 and the issued probe response accumulator 245.

The local response accumulator 240 includes a number of entries (e.g., entry 241), wherein each entry is assigned to a different received coherency probe. Each entry includes a probe response count field (e.g., probe response count field 242) that stores a value indicating the number of coherency agents of the processing module 102 for which probe responses have been received responsive to the corresponding coherency probe. Each entry of the local response accumulator 240 also includes an accumulated coherency state field (e.g., accumulated coherency state field 243) indicating the combined coherency state for the probe responses received responsive to the corresponding coherency probe.

The issued probe response accumulator 245 includes a number of entries (e.g., entry 241), wherein each entry is assigned to a different coherency probe issued by the coherency manager 130. Each entry includes a probe response count field (e.g., probe response count field 247) that stores a value indicating the number of coherency agents of the processing modules 102-104 for which probe responses have been received responsive to the corresponding coherency probe. Each entry of the issued probe response accumulator 240 also includes an accumulated coherency state field (e.g., accumulated coherency state field 248) indicating the combined coherency state for the probe responses received responsive to the corresponding coherency probe.

In operation, in response to receiving a coherency probe from the switch fabric 112, the accumulator control module 250 assigns an entry of the local response accumulator 240 to the coherency probe and provides the coherency probe to the coherency manager 130. The coherency manager 130 generates a probe response for each of its connected coherency agents and provides the probe responses to the probe response accumulator 135. In response to receiving a probe response, the accumulator control module 250 modifies the probe response count field for the coherency probe to indicate an additional response has been received, and modifies the accumulated coherency state field to indicate the highest state in the coherency protocol hierarchy among all the probe responses so far received. Once the probe response count field for an entry reaches a threshold level, the accumulator control module 250 provides a combined probe response to the switch fabric 112, wherein the combined probe response indicates the accumulated coherency state field 243 and the number of probe responses indicated by the probe response count field 242.

An example operation of the probe response accumulator 135 is illustrated at FIG. 3 in accordance with some embodiments. At time 301 the accumulator control module 250 receives a coherency probe from the switch fabric 112 and in response allocates entry 241 of the local response accumulator 240 to the coherency probe. In addition, the accumulator control module 250 sets the probe response count field 242 to zero and the accumulated coherency state field 243 to a reset value, indicates as “X” in the depicted example. At time 302 the accumulator control module 250 receives from the coherency manager 130 a probe response 310 indicating a coherency state of invalid (“I”). In response the accumulator control module 250 increases the probe response count field 242 to one and sets the accumulated coherency state field 243 to the invalid state.

At time 303 the accumulator control module 250 receives from the coherency manager 130 a probe response 311 indicating a coherency state of exclusive (“E”). In response the accumulator control module 250 increases the probe response count field 242 to 2. In addition, the accumulator control module 250 logically combines the encoding of the exclusive state with the stored encoding of the invalid state, resulting in the accumulated coherency state field 243 being set to the exclusive state (reflecting that the exclusive state is higher in the coherency protocol than the invalid state).

At time 304 the accumulator control module 250 receives from the coherency manager 130 a probe response 312 indicating a coherency state of forward (“F”). In response the accumulator control module 250 increases the probe response count field 242 to 3. In addition, the accumulator control module 250 logically combines the encoding of the forward state with the stored encoding of the exclusive state, resulting in the accumulated coherency state field 243 being maintained at the exclusive state (reflecting that the exclusive state is higher in the coherency protocol than the forward state). In addition, the accumulator control module 250 determines that the probe response count field 242 matches an issue threshold, and in response issues a combined probe response to the processing module that generated the coherency probe. In some embodiments, the issue threshold is set to correspond to the total number of coherency agents at the processing module 104, so that the combined probe response is not issued until probe responses have been received for all of the coherency agents at the processing module 104. The combined probe response includes the value of the probe response count field 242 to indicate the number of probe responses reflected in the combined probe response. The combined probe response also includes the value stored at the accumulated coherency state field 243 to indicate the highest coherency state in the coherency protocol among the received probe responses.

The accumulator control module 250 manages the entries of the issued probe response accumulator 245 in analogous fashion to the local response accumulator 240. An example of such management is illustrated at FIG. 4 in accordance with some embodiments. At time 401 the accumulator control module 250 receives a coherency probe issued by a coherency manager and in response allocates entry 246 of the issued probe response accumulator 245 to the coherency probe. In addition, the accumulator control module 250 sets the probe response count field 247 to zero and the accumulated coherency state field 248 to a reset value, indicates as “X” in the depicted example. The accumulator control module 250 communicates the coherency probe to the switching fabric 112.

At time 402 the accumulator control module 250 receives from the switching fabric 112 a combined probe response 410 indicating a probe response count of 3 and a coherency state of invalid (“I”). This indicates that the combined probe response reflects three individual probe responses, with a combined coherency state of invalid. In response to the combined probe response 410 the accumulator control module 250 increases the probe response count field 247 to 3 and sets the accumulated coherency state field 248 to the invalid state.

At time 403 the accumulator control module 250 receives from the switch fabric 112 a combined probe response 511 indicating a probe response count of two and a coherency state of modified (“M”). In response the accumulator control module 250 increases the probe response count field 247 to 5. In addition, the accumulator control module 250 logically combines the encoding of the modified state with the stored encoding of the invalid state, resulting in the accumulated coherency state field 248 being set to the modified state (reflecting that the modified state is higher in the coherency protocol than the invalid state).

At time 404 the accumulator control module 250 receives from the switch fabric 112 a probe response 412 indicating a probe response count of four and a coherency state of shared (“S”). In response the accumulator control module 250 increases the probe response count field 242 to seven. In addition, the accumulator control module 250 logically combines the encoding of the shared state with the stored encoding of the modified state, resulting in the accumulated coherency state field 243 being maintained at the modified state (reflecting that the modified state is higher in the coherency protocol than the shared state). In addition, the accumulator control module 250 determines that the probe response count field 242 matches an issue threshold, and in response issues a combined probe response to the coherency manager 130. In some embodiments, the issue threshold is set to correspond to the total number of coherency agents at the processing modules 102-104, so that the combined probe response is not issued until probe responses have been received for all of the coherency agents at the processing modules 102-104.

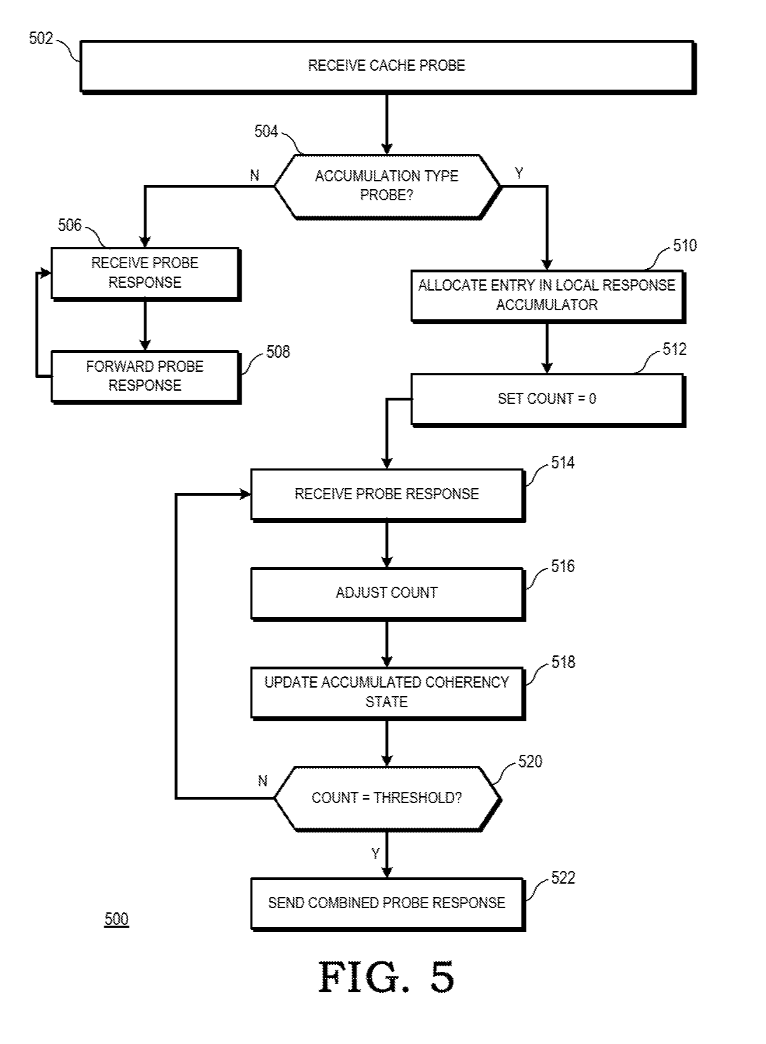

FIG. 5 is a flow diagram of a method 500 of accumulating coherency probe responses at the probe response accumulator 135 in accordance with some embodiments. At block 502, the probe response accumulator 135 receives a coherency probe from the switch fabric 112. In response, at block 504 the accumulator control module 250 determines whether the received coherency probe is of a type whereby the probe responses can be accumulated (e.g., a coherency status probe). If not, the method flow moves to block 506 and the accumulator control module 250 receives a probe response for the received coherency probe from the coherency manager 130. Because the coherency probe is of a type where the probe responses cannot be accumulated, the method flow proceeds to block 508 and the probe response accumulator 135 forwards the received probe response to the switch fabric 112. The method flow returns to block 506, and the probe response accumulator 135 forwards all of the probe responses for the coherency probe without accumulation.

Returning to block 504, if the received coherency probe is of a type wherein the probe responses can be accumulated, the method flow moves to block 510 and the accumulator control module 250 allocates an entry at the local response accumulator 240 to the coherency probe. At block 514 the accumulator control module 250 sets the probe response count field for the allocated entry to zero and sets the accumulated coherency state field for the entry to a reset state designated as “X”.

At block 514 the accumulator control module 250 receives from the coherency manager 130 a probe response to the coherency probe. In response, at block 516 the accumulator control module 250 increments the probe response count field for the allocated entry. At block 518, the accumulator control module 250 updates the accumulated coherency state field for the allocated entry based on the coherency state indicated by the received probe response. At block 520 the accumulator control module 250 determines whether the probe response count field for the allocated entry equals a response issue threshold. If not, the method flow returns to block 514 and the accumulator control module 250 awaits additional responses. If, at block 520, the probe response count field equals the response issue threshold, the method flow proceeds to block 522 and the accumulator control module 250 sends a combined probe response for the coherency probe, the combined probe response indicating the accumulated coherency state and the probe response count as stored at the local response accumulator 240. The probe response count can be used by the coherency manager that issued the cache probe to determine whether and when all expected probe responses have been received.

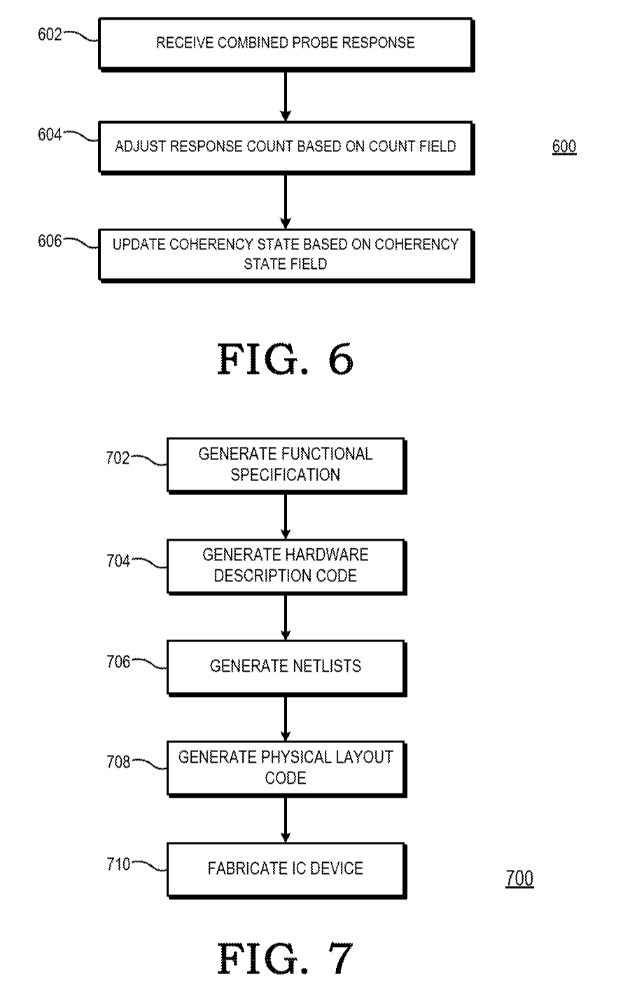

FIG. 6 is a flow diagram of a method 600 of accumulating probe responses at the issued probe response accumulator 245 of FIG. 2 in accordance with some embodiments. At block 602 the accumulator control module 250 receives, responsive to a previously issued coherency probe, a combined probe response. At block 604 the accumulator control module 250 identifies the entry of the issued probe response accumulator 245 that was allocated to the issued coherency probe and adjusts the probe response count field by the probe response count indicated in the combined probe response. At block 606 the accumulator control module 250 updates the accumulated coherency state field for the allocated entry based on the coherency state indicated in the combined probe response.

In some embodiments, the apparatus and techniques described above are implemented in a system comprising one or more integrated circuit (IC) devices (also referred to as integrated circuit packages or microchips), such as the processor described above with reference to FIGS. 1-6. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

FIG. 7 is a flow diagram illustrating an example method 700 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 702 a functional specification for the IC device is generated. The functional specification (often referred to as a micro architecture specification (MVAS)) may be represented by any of a variety of programming languages or modeling languages, including C, C++, SystemC, Simulink, or MATLAB.

At block 704, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 706 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 708, one or more EDA tools use the netlists produced at block 706 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 710, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
responsive to a first coherency probe, receiving a plurality of coherency probe responses at a first node of a processor;
combining the plurality of coherency probe responses into a combined probe response; and
communicating the combined probe response to a second node of the processor as a response to the first coherency probe.

2. The method of claim 1, wherein:
combining the plurality of coherency probes comprises maintaining a count of the plurality of coherency probe responses; and
communicating the combined probe response comprises communicating the combined probe response in response to determining the count has reached a threshold level.

3. The method of claim 2, wherein the threshold level is equal to a number of coherency agents coupled to the node of the processor.

4. The method of claim 1, wherein combining the plurality of coherency probe responses comprises:
responsive to receiving a first coherency probe response at a first time, setting a field of the combined probe response to indicate a first coherency state; and
in response to receiving a second coherency probe response at a second time, modifying the field to indicate a second coherency state different from the first.

5. The method of claim 4, wherein modifying the field comprises modifying the responsive to determining the second coherency probe indicates a different response than the first coherency probe.

6. The method of claim 4, wherein the field comprises a field configured to indicate an identifier for an agent responding to coherency probes.

7. The method of claim 1, wherein the first node of the processor comprises a transport switch of the processor.

8. The method of claim 1, wherein combining the plurality of coherency probe responses comprises combining the plurality of coherency probe responses in response to the first coherency probe being of a first probe type.

9. The method of claim 8, further comprising:
responsive to a second coherency probe, receiving a coherency probe response at the first node of the processor; and
responsive to the second coherency probe being of a second probe type different than the first probe type, communicating the coherency probe response to the second node of the processor without combining the coherency probe response with other coherency probe responses.

10. A method, comprising
responsive to a first coherency probe, receiving at a first node of a processor a first response from a cache; and
in response to the first response being a combined probe response:
identifying a number of coherency probe responses represented by the first cache response; and
adjusting a count of coherency probe responses based on the number.

11. The method of claim 10, further comprising:
in response to the first response not being a combined probe response, adjusting the count of coherency probe responses by one.

12. The method of claim 10, further comprising:
identifying that the first cache response is a combined probe response based on a field of the coherency probe response.

13. A processor, comprising:
a first node to receive a plurality of coherency probe responses responsive to a first coherency probe;
a probe response accumulator to combine the plurality of coherency probe responses into a combined probe response; and
a switch fabric to communicate the combined probe response to a second node of the processor as a response to the first coherency probe.

14. The processor of claim 13, wherein the probe response accumulator is to:
maintain a count of the plurality of coherency probe responses; and
communicate the combined probe response to the switch fabric in response to determining the count has reached a threshold value.

15. The processor of claim 14, wherein the threshold value is equal to a number of coherency agents coupled to the node of the processor.

16. The processor of claim 13, wherein the probe response accumulator is to:
in response to receiving a first coherency probe response at a first time, set a response field of the combined probe response to indicate a first coherency state; and
in response to receiving a second coherency probe response at a second time, modify the response field to indicate a second coherency state different from the first.

17. The processor of claim 16, wherein the probe response accumulator is to:
modify the response field comprises in response to determining the second coherency probe indicates a different response than the first coherency probe.

18. The processor of claim 16, wherein the response field comprises a field configured to indicate an identifier for an agent responding to coherency probes.

19. The processor of claim 13, wherein the first node of the processor comprises a transport switch of the switch fabric.

20. The processor of claim 13, wherein the probe response accumulator is to:
combine the plurality of coherency probe responses in response to the first coherency probe being of a first probe type.
